(19) United States
(12) Patent Application Publication
(10) Pub. No.: US 2003/0042333 A1
(43) Pub. Date: Mar. 6, 2003

(54) Spray gun having multiple size handles

(76) Inventors: Roger E. Wiersma, Forest Lake, MN (US); Jeffrey S. Swanson, Andover, MN (US)

Correspondence Address: Douglas B. Farrow, Graco Minnesota Inc., P.O. Box 1441, Minneapolis, MN, 55440-1441, US

(21) Appl. No.: 10/236,815

(22) Filed: Sep. 6, 2002

Related U.S. Application Data
(60) Provisional application No. 60/317,806, filed on Sep. 6, 2001.

(51) Int. Cl. B05B 7/02

(52) U.S. Cl. 239/525

(57) ABSTRACT

An electrostatic hand (manual) spray gun is provided with a body having a molded handle shaped for smaller hands. One or more grips may be provided which snap on over the molded handle to provide a properly shaped and sized handle for larger hands.

### RELATED APPLICATIONS

This application claims the benefit of U.S. application Ser. No. 60/317,806, filed Sep. 6, 2001.

### BACKGROUND OF THE INVENTION

Electrostatic spray guns have proven to be useful tools for efficient application of paints and coatings. Compared to non-electrostatic guns, such tools have proven relatively heavy and bulky. Accordingly, ergonomics assume an increased importance with such guns.

### SUMMARY OF THE INVENTION

An electrostatic hand (manual) spray gun is provided with a body having a molded handle shaped for smaller hands. One or more grips may be provided which snap on over the molded handle to provide a properly shaped and sized handle for larger hands.

These and other objects and advantages of the invention will appear more fully from the following description made in conjunction with the accompanying drawings wherein like reference characters refer to the same or similar parts throughout the several views.

### A BRIEF DESCRIPTION OF THE DRAWINGS

FIG. 1 is an exploded view showing the spray gun with one set of grips.

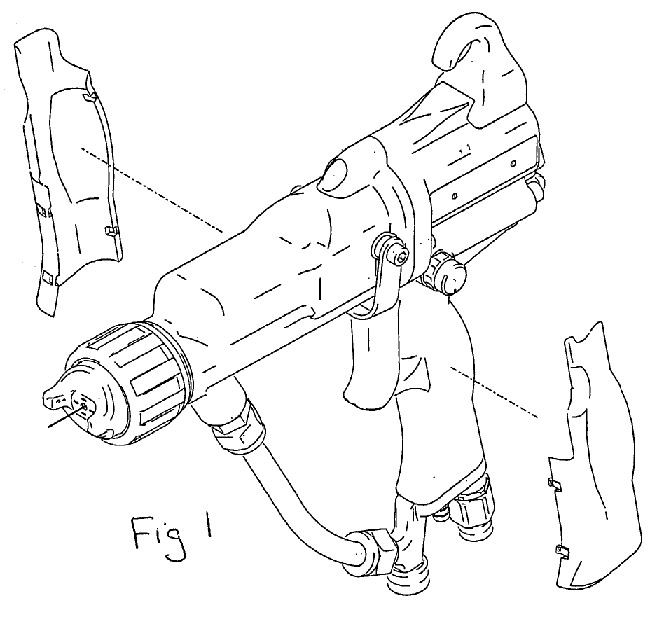

### DESCRIPTION OF THE PREFERRED EMBODIMENT

It is contemplated that various changes and modifications may be made to the spray gun without departing from the spirit and scope of the invention as defined by the following claims.

What is claimed is:

1. In a spray gun comprising a body having a molded handle, the improvement comprising at least one set of grips sized and shaped to snap on over said molded handle to provide a properly shaped and sized handle for larger hands.
